(19) United States
(12) Patent Application Publication
(10) Pub. No.: US 2006/0224751 A1
(43) Pub. Date: Oct. 5, 2006

(54) Storage system, a host adapter, a data storage, a method of controlling a node device, a method of controlling a host adapter, a signal-bearing medium embodying a program causing a host adapter to perform a method of controlling a storage system, and a signal-bearing medium embodying a program causing a digital processing apparatus to perform a method of controlling a host adapter

(75) Inventor: Atsushi Kuwata, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/390,364

(22) Filed: Mar. 28, 2006

(30) Foreign Application Priority Data
Mar. 31, 2005 (JP) 2005-104169

(51) Int. Cl. G06F 15/16

(52) U.S. Cl. 709/229

(57) ABSTRACT

A storage system for use with a node device, includes host modules that access the node device based on an address conversion information. The node device is connectable to the host modules and includes the address conversion information.

### BACKGROUND OF THE INVENTION

The present invention relates to an integrated storage system in which computers share a storage device or storage devices, or storage devices are accessed by a computer or computers.

Particularly, the present invention relates to a storage system, a host adapter, a node device, a method of controlling a storage system, a method of controlling a host adapter, a signal-bearing medium embodying a program causing a host adapter to perform a method of controlling a storage system, and a signal-bearing medium embodying a program causing a digital processing apparatus to perform a method of controlling a host adapter, having the technology for resetting of address information which occurs in accordance with a change of topology.

Recently, for example, attempts to construct an integrated storage by combining a plurality of small-scale storage devices and a switch device have been made. Such integrated storage enables the easy increase of the capacity of a storage device and allows high scalability, and in addition, compared to introducing a large-scale device to obtain the same capacity, costs are kept low.

Existing systems, for example, include a storage area network management system in which security management is automatically conducted (JP-A No. 63063/2002), or an integrated storage system that enables the handling of a large number of storage devices on a network as a centralized image by viewing them from a higher-level device (JP-A No. 296154/2003).

FIG. 15 shows a conventional system wherein storage devices 94 and switch devices 93 are combined. In FIG. 15, volume manager software 92 is installed into each of host computers 91. In each host computer 91, when an application carries out disk accesses, volume manager software 92 converts address information and conducts input and output processing.

### SUMMARY OF THE INVENTION

However, in each conventional system mentioned above, since software integrates and manages each device, there are many problems.

For example, at the time of adding a data storage (e.g., increase in capacity of data storage), logical settings for how a host computer responds to an increased disk may be necessary. For this reason, a human entry-level error may easily occur and a system in operation may be affected.

For example, at the time of adding a host, logical settings for showing the volume of the storage device to the additional host computer may be necessary, and in this case as well, a human entry-level error may easily occur and a system in operation may be affected.

For example, regarding management of hardware, such as parts failure management of each component, information unique to the component needs to be processed and it may be difficult to conduct unified integrated management.

In addition, in the existing technology mentioned above, address information is managed by software and therefore, overhead for the host computer processing increases. To solve this problem, address conversion may be conducted within a switch device by introducing an intelligent switch. However, in spite of having such a construction, the above-mentioned problems still exist and problems may occur.

For example, when replacement is made due to a fault in a switch device, resetting of address conversion information may be necessary and in this case as well, a system in operation may be affected, because of a human error.

In view of the foregoing and other exemplary problems, drawbacks, and disadvantages of the conventional techniques, it is an exemplary feature of the present invention to provide a storage system, a host adapter, a node device, a method of controlling a storage system, a method of controlling a host adapter, a signal-bearing medium embodying a program causing a host adapter to perform a method of controlling a storage system, and a signal-bearing medium embodying a program causing a digital processing apparatus to perform a method of controlling a host adapter.

For example, the present invention may provide a storage system in which logical setting work may not be necessary at the installation location and occurrence of human error may be eliminated, when adding or replacing a node device.

The present invention provides a storage system for use with a node device; the storage system includes host modules that access the node device based on an address conversion information. The node device is connectable to the host modules and includes the address conversion information.

The present invention also provides a storage system for use with a host adapter; the storage system includes node devices, and a host computer that accesses the node devices. The host adapter is connectable to the host computer and controls data transfer between the host computer and the node devices, and the host adapter includes the address conversion information.

The present invention also provides a host adapter within a storage system for use with a node device; the storage system includes a host computer. The node device is connectable to the host computer and includes an address conversion information, and the host adapter controls data transfer between the host computer and the node device based on the address conversion information.

The present invention also provides a host adapter within a storage system for use with a host adapter; the storage system includes node devices, and a host computer that accesses the node devices. The host adapter includes an address conversion information. The host adapter is connectable to the host computer and controls data transfer between the host computer and the node devices.

The present invention also provides a data storage within a storage system for use with a node device includes host modules that access the node device based on an address conversion information. The node device includes the address conversion information. The node device is connectable to the host modules.

The present invention also provides a method of controlling a storage system for use with a node device, the storage system includes a host computer, and a host adapter that controls data transfer between the host computer and a node device based on an information of address conversion between the host computer and the node device, the node device being connectable to the storage system. The method includes retrieving, by the host adapter, the address conversion information from the node device.

The present invention also provides a method of controlling a host adapter within a storage system; the storage system includes node devices, and a host computer that accesses one of the node devices. The host adapter is connectable to the host computer and controls data transfer between the host computer and the node device. The host adapter includes information of address conversion between the host adapter and the node device. The method includes increasing a number of the host adapter, and the host adapter writing the address conversion information to one of the node devices.

The present invention also provides a signal-bearing medium embodying a program of machine-readable instructions executable by a digital processing apparatus, the program causing a host adapter to perform a method of controlling a storage system for use with a node device described above.

The present invention also provides a signal-bearing medium embodying a program of machine-readable instructions executable by a digital processing apparatus, the program causing the digital processing apparatus to perform a method of controlling a host adapter within a storage system described above.

[Exemplary Advantage]

The present invention may provide a storage system in which logical setting work may not be necessary at the installation location and occurrence of human error may be eliminated, when adding or replacing a node device.

This may be because a storage system may include host modules that accesses a node device based on an address conversion information. The node device may be connectable to the host modules and may include the address conversion information.

### BRIEF DESCRIPTION OF THE DRAWINGS

The novel and exemplary features believed characteristic of the invention are set forth in the appended claims. The invention itself, however, as well as other exemplary features and advantages thereof, will be best understood by reference to the detailed description which follows, read in conjunction with the accompanying drawings, wherein:

FIG. 1 is an exemplary block diagram showing a first exemplary embodiment of the present invention;

FIG. 2 is an exemplary block diagram showing a second exemplary embodiment of the present invention;

FIG. 3 is an exemplary schematic block diagram showing an exemplary configuration of host adapter HADi disclosed in FIGS. 1 and 2;

FIG. 4A is an exemplary explanatory diagram showing an exemplary structure of address conversion information ACIdj of each storage device SDj in FIG. 2;

FIG. 4B is an exemplary explanatory diagram showing an exemplary structure of address conversion information ACIhi of each host adapter HADi in FIG. 2;

FIG. 5A is an exemplary explanatory diagram showing an exemplary structure of address conversion information ACId0 of storage SD0 in FIG. 2;

FIG. 5B is an exemplary explanatory diagram showing an exemplary structure of address conversion information ACIh00 of host adapter HAD00 in FIG. 2;

FIG. 6 is an exemplary flowchart showing functioning of the entire system 2 at the time of start in an exemplary storage system 2 in FIG. 2;

FIG. 7 is an exemplary flowchart showing functioning of host adapter i at the time of a storage device j being increased in an exemplary storage system 2 in FIG. 2;

FIG. 8 is an exemplary flowchart showing functioning of host adapter i at the time of increase of a host adapter i accompanying increase of a host in an exemplary storage system 2 in FIG. 2;

FIG. 9 is an exemplary block diagram showing an exemplary configuration of an integrated storage system 3 wherein information of network elements is managed in an integrated manner according to a third exemplary embodiment of the present invention;

FIG. 10 is an exemplary block diagram showing an exemplary state wherein an exemplary disk device 115 is added to a storage device 21 according to a fourth exemplary embodiment in the present invention;

FIG. 11 is an exemplary flowchart of processing at the time of an exemplary disk 115 device being added to a storage device 21 according to the fourth exemplary embodiment in the present invention;

FIG. 12 is another exemplary flowchart showing functioning of the entire system 2 at the time of start in the exemplary storage system 2 in FIG. 2;

FIG. 13 is another exemplary flowchart showing functioning of the entire system 2 at the time of a storage device j being increased in an exemplary storage system 2 in FIG. 2;

FIG. 14 is another exemplary flowchart showing functioning of host adapter i at the tine of increase of a host adapter i accompanying increase of a host in an exemplary storage system 2 in FIG. 2; and

FIG. 15 is an exemplary explanatory diagram showing an exemplary conventional system.

### DETAILED DESCRIPTION OF THE EXEMPLARY EMBODIMENTS

An integrated storage system relating to the present invention may be an integrated storage device combining a plurality of single storage devices (hereinafter referred to as a “storage device”), a switch device switching and connecting each storage device to a corresponding computer (e.g., a host computer), a host adapter module as a host adapter device to be connected to the switch device (hereinafter simply referred to as a “host adapter”), and one, two or more computers accessing each aforesaid storage device via the host adapter and aforesaid switch device. The word “host module” described below may refer to a combination of a host computer and a host adapter.

Each aforesaid storage device stores address conversion information for each host adapter and the host adapter takes in such information. Therefore, the work procedure at the time of increase in capacity, maintenance and replacement may be unnecessary. A scalable storage system wherein management may be easily made is provided. This is a characteristic of an integrated storage system relating to the present invention. In accordance with the attached drawings, exemplary embodiments of the present invention are consecutively described as follows.

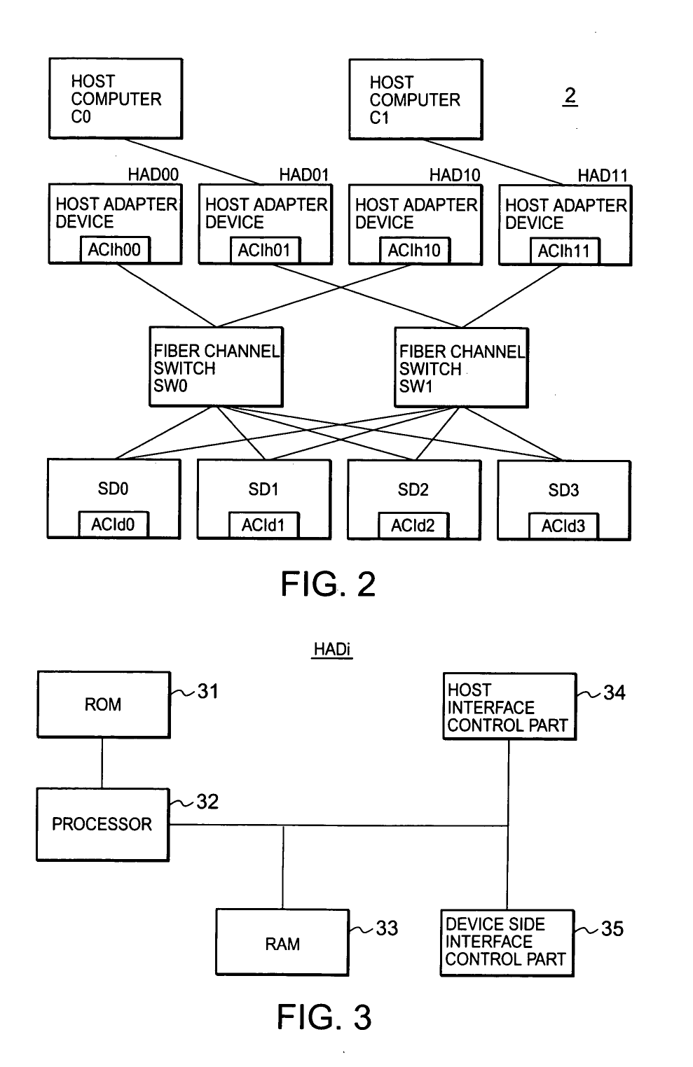

At this point, when the same element is shown in a plurality of drawings, the same reference numeral is used. Acronyms to be used in the exemplary embodiment have the following meaning.
HBA: Host Bus Adapter
HAD: Host Adapter
ACIh: Address Convert Information for Host adapter
SD: Storage Device
ACId: Address Convert Information for Disk adapter
C (FIG. 2): Computer
SW (FIG. 2): Switch

### First Exemplary Embodiment

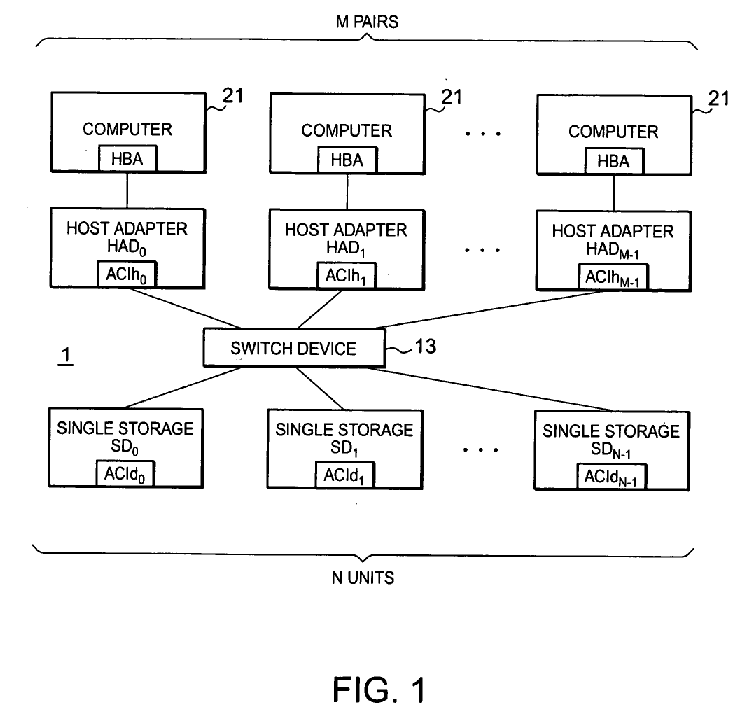

FIG. 1 is an exemplary block diagram showing a first exemplary embodiment of the present invention. An integrated storage system 1 includes a plurality of node devices (e.g., single storage devices SD₀, SD₂, . . . SD_{N-1}) that are connected to a switch device 13, at least one computer (in this exemplary embodiment, M-1 computers) 21 that access at least each of aforesaid single storage device via switch device 13. Between switch device 13 and each of computers (host computer) 21, host adapter devices HAD₀ to HAD_{M-1} that control data transfer between host computers 21 and each of single storage devices SD₀ to SD_{N-1} via a relevant switch device, are installed separately and corresponding to each of aforesaid computers 21. HBA in FIG. 1 is an abbreviation for host bus adapter.

A construction is provided in which each of the node devices (e.g., storage devices SD₀ to SD_{N-1}) stores in advance address conversion information for each of host adapter devices HAD₀ to HAD_{M-1} and hereby, at the time of increase in capacity, maintenance and replacement, resetting of address information can be made as desired. For this reason, according to this construction, a resetting that is made at the time of increase in capacity, may be completely automated. Therefore, human manual operation may be removed at the installation location. Consequently, system failure caused by human error can be minimized, if not eliminated.

At this point, a construction may be provided in which at the time of reading address conversion information from storage devices SD₀ to SD_{N-1}, host adapter devices HAD₀ to HAD_{M-1} have a conversion information reading function that is executed after all of storage devices SD₀ to SD_{N-1} start. The exemplary configuration of host adapter devices HAD will be discussed below in the second exemplary embodiment.

In addition, a construction may be provided in which when a new storage device is added to aforesaid storage devices SD₀ to SD_{N-1}, aforesaid host adapter devices HAD₀ to HAD_{M-1} have functions to read address conversion information relating to a relevant storage device from a relevant new storage device, and at the same time, set the corresponding computer to be able to search relevant storage device. For these constructions, further description is given as follows.

As described above, FIG. 1 is a block diagram that shows an exemplary integrated storage system according to the basic exemplary embodiment of the present invention. For example in FIG. 1, integrated storage system 1 includes a switch device 13 including a fiber channel switch and the like, N units of single storage devices SD₀, SD₁, . . . SD_{N-1} that are connected to switch device 13, M units of host adapters HAD₀, HAD₁, . . . , HAD_{M-1} that are connected to the switch device 13, and a plurality of computers 21 that are separately connected to each host adapter HADi (i=1, 2, . . . , M−1). At this point, host adapter HADi is connected to storage device SDj via switch device 13 and has a function to control data transfer between host computer 21 and storage device SDj.

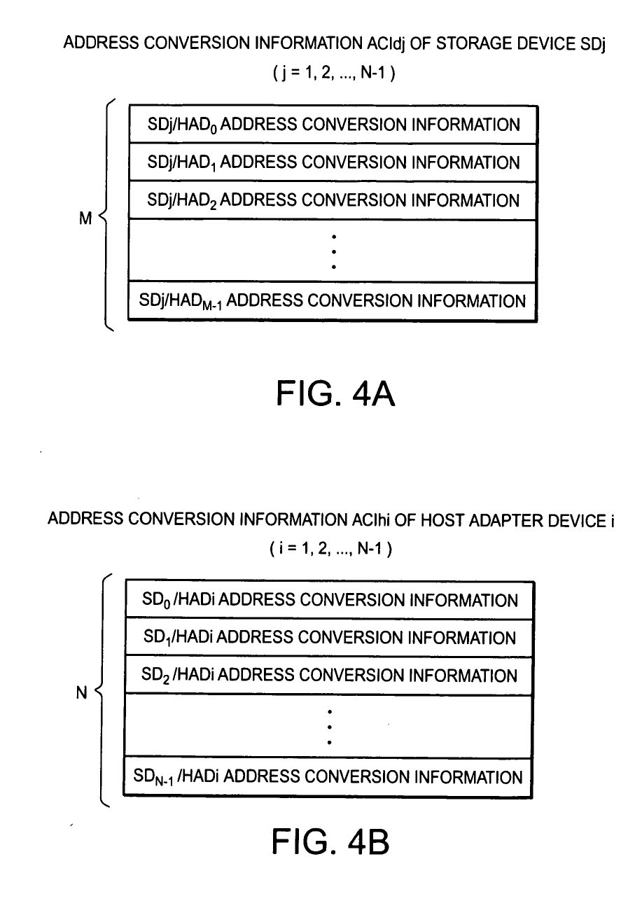

Each storage device SDj (j=1, 2, . . . N−1) holds a volume (e.g., to store information) within its own device and address conversion information ACIdj relating to host adapters HAD₀, HAD₁, . . . , HAD_{M-1}. At this point, FIG. 4A is an exemplary explanatory diagram showing an exemplary structure of address conversion information ACIdj of each storage device SDj in FIG. 2. As shown in FIG. 4A, address conversion information ACIdj includes address conversion information for its own device SDj and all host adapters, such as SDj/HAD₀ address conversion information, SDj/HAD₁ address conversion information, SDj/HAD₂ address conversion information, . . . , SDj/HAD_{M-1} address conversion information.

Meanwhile, each host adapter HADi takes in address conversion information relating to storage devices SD₀ to SD_{N-1} and its own host adapter HADi from each storage device SDj and holds address conversion information ACIhi. At this point, FIG. 4B is an exemplary explanatory diagram showing an exemplary structure of address conversion information ACIhi of each host adapter HADi in FIG. 2. As shown in FIG. 4B, address conversion information ACIhi includes address conversion information for its own device HADi and all storage devices, such as SD₀/HADi address conversion information, SD₁/HADi address conversion information, SD₂/HADi address conversion information, . . . , SD_{N-1}/HADi address conversion information.

By conducting address conversion according to address conversion information ACIhi, host adapter HADi discloses the volume that actually exists in storage devices SD₀ to SD_{N-1}, as a volume of a unit of an integrated storage device, to computer 21. Regarding a single storage device to be added SD_{N} (not illustrated), by having SD_{N} hold address conversion information at the stage of shipping, it is possible to add volume (capacity) without setting volume management information at an installation location at the time of increase.

In this way, in the first exemplary embodiment, a node device to be added (e.g., storage device to be added SD_{N} (not illustrated)) holds address conversion information at the stage of shipping and when the increase is made, host adapter HADi voluntarily takes information in and updates address conversion information ACIhi. Therefore, at an installation location, the operation to increase capacity can be carried out quickly and efficiently without setting volume management information.

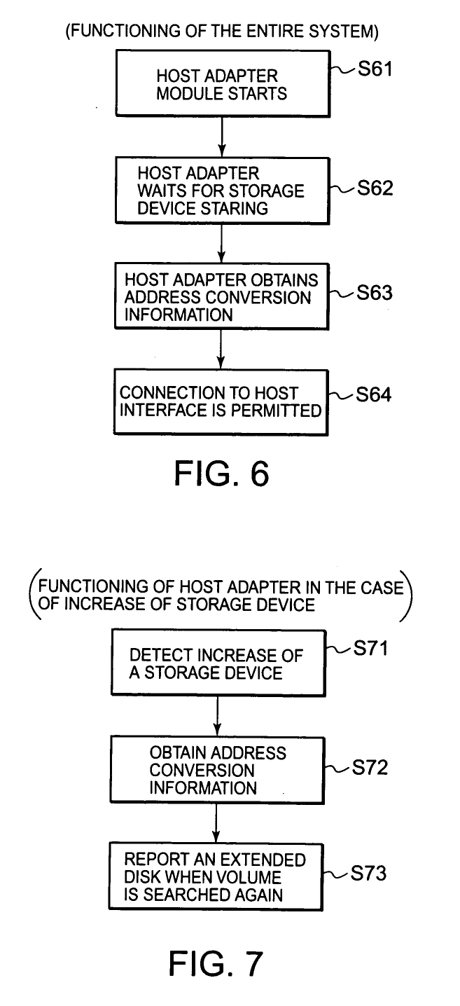

The exemplary operation of system 1, host adapter, and storage device will be shown in FIGS. 6,-8 in the second exemplary embodiment described below.

### Second Exemplary Embodiment

Next, a second exemplary embodiment is described based on FIG. 2. In FIG. 2, two switch devices SW0 and SW1 are installed. For each of switch devices SW0 and SW1, four storage devices SD0 to SD3 are jointly installed. At least one computer (in FIG. 2, two host computers C0 and C1) that accesses each of aforesaid storage devices SD0 to SD3 via each of switch devices SW0 and SW1, is installed. An integrated storage system 2 includes these devices.

Among them, between aforesaid switch devices SW0, SW1 and computers C0, C1, four host adapter devices HAD00 to HAD11 that control data transfer between aforesaid computers C0, C1 and each of storage devices SD0 to SD3 via relevant switch devices SW0 and SW1, corresponding and linking to aforesaid computers C0 and/or C1, are installed as shown in FIG. 2. A construction is provided in which each of host adapter devices HAD00 to HAD11 holds in advance prescribed address conversion information. In addition, a construction is provided in which at the time of increase, maintenance and replacement of relevant host adapter devices HAD00 to HAD11, resetting of address information for each of storage devices SD0 to SD3 can be made as desired.

Therefore, according to these constructions, at the time of new increase in host computers C0 and C1 (increase in host adapter device), as described above, the setting is made in which prescribed address conversion information is automatically written into each of a plurality of storage devices SD0 to SD3. This enables the complete automation of resetting. It is also designed so that human manual operations are unnecessary. This enables effective elimination of system failure previously caused by human error in the conventional systems.

At this point, a construction may be provided in which aforesaid host adapter devices HAD00 to HAD11 function when a new storage device is added to aforesaid storage device SD0 to SD3 and have a conversion information writing function that writes prescribed address conversion information into a relevant new storage device as mentioned above when the entire system starts. Further description is given as follows.

As described above, FIG. 2 shows a configuration of an integrated storage device according to the second exemplary embodiment of the present invention. In FIG. 2, an integrated storage system 2 includes two fiber channel switches (hereinafter referred to as an “FC switch”) SW0 and SW1, four units of storage devices SD0 to SD3 that are connected to each of FC switches, host adapters HAD00 and HAD10 that are connected to FC switch SW0—one of aforesaid FC switches, host adapters HAD01 and HAD11 that are connected to FC switch SW1—the other of aforesaid FC switches, host computer C0 that is connected to the aforesaid host adapters HAD00 and HAD01 and host computer C1 that is connected to host adapters HAD10 and HAD11.

Each host adapter HADkm (k=0, 1, m=0, 1) functions in accordance with commands from the host computer Ck and has a function to control data transfer between host computer Ck and storage device SDj (j=0 to 3). Host adapter HADkm and storage device SDj are connected by fiber channel interface (hereinafter referred to as “FC interface”) via FC switches SW0 and SW1. Storage device SDj has an FC interface and in general, may be a disk array device and includes a large volume.

FIG. 3 is an exemplary schematic block diagram showing an exemplary configuration of host adapter HADi disclosed in FIGS. 1 and 2. As evident to one of ordinary skill in the art, this exemplary schematic block diagram can be applied to other exemplary embodiments.

In FIG. 3, host adapter HADkm includes processor 32, ROM—Read Only Memory—31 that can be accessed by the processor, RAM—Random Access Memory—33 that is interconnected by a bus, host interface control part 34 and device side interface control part 35. Host interface control part 34 conducts interface control for host computer Ck and device side interface control part 35 conducts interface control for storage device SDj via switch device SWm.

Processor 32 judges the content of commands given by host computer Ck and based on address conversion information stored in RAM 33, issues a converted command to storage device SDj and controls data transfer between host interface control part 34 and device side interface control part 35. In addition, processor 32 voluntarily issues a command to receive address information from storage device SD0 to SD3 via device side interface control part 35. ROM 31 stores a functioning program of host adapter HADkm and in addition, when host adapter HADₖₘ₊₁ (not illustrated) is added, stores address conversion information ACIhₖₘ₊1 (not illustrated).

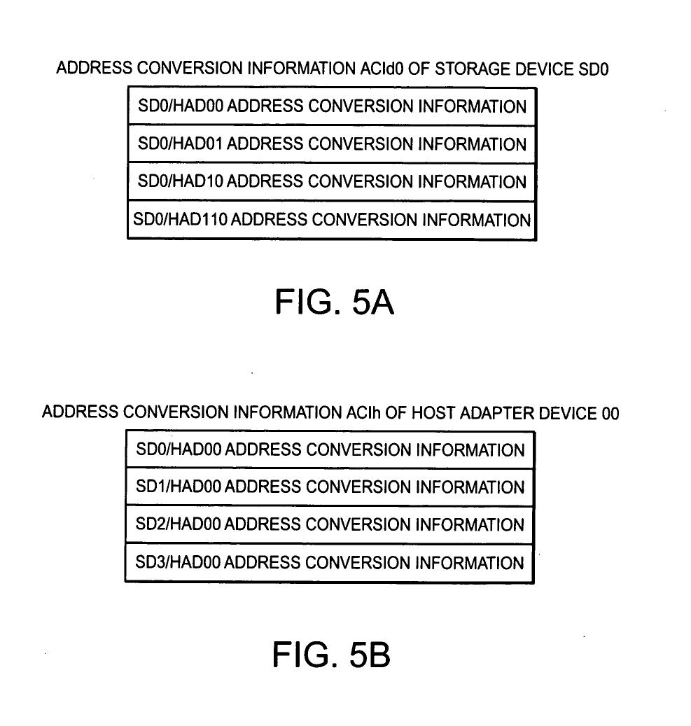

FIG. 5A is an exemplary explanatory diagram showing an exemplary structure of address conversion information ACId0 of storage SD0 in FIG. 2. Though FIG. 5A may be substantially the same as FIG. 4A, FIG. 5A is shown as another representation slightly different from FIG. 4A.

Address conversion information ACId0 includes address conversion information for all of host adapters HADkm, which are objects of service, that is to say, SD0/HAD00 address conversion information, SD0/HAD01 address conversion information, SD0/HAD10 address conversion information and SD0/HAD11 address conversion information. Address information ACIdj held by storage device SDj is a set of information by which each host adapter shows volume held by the storage to host computer Ck.

Moreover, FIG. 5B is an exemplary explanatory diagram showing an exemplary structure of address conversion information ACIh00 of host adapter HAD00 in FIG. 2. Though FIG. 5B may be substantially the same as FIG. 4B, FIG. 5B is shown as another representation slightly different from FIG. 4B.

Address conversion information ACIh00 includes address conversion information of all storage devices SD0 to SD3 that can be accessed by host adapter HAD00 (e.g., SD0/HAD00 address conversion information to SD3/HAD00 address conversion information). Address information held by host adapter HADkm includes a set of information by which host adapter device HADkm shows a volume held by each storage device SDj to host computer Ck and a set of information which host adapter HADkm has obtained by reading the information held by each storage device SDj.

For fiber channel switches (FC switches) SW0, SW1 as a switch device and storage device SDj in above-mentioned FIG. 2, a widely known configuration is used. In addition, in the above-mentioned exemplary embodiment, for the interface of switch device SW0, SW1 and connection bus, Ethernet (registered trademark) and TCP/IP (Transmission Control Protocol/Internet Protocol) may be used.

Next, FIG. 6 is an exemplary flowchart showing a functioning of the entire system 2 at the time of start in an exemplary storage system 2 in FIG. 2. As evident to a person skilled in the art, function described in FIG. 6 may be applied to other exemplary embodiments.

In FIG. 6, in step 61 when the power supply is turned on and integrated storage system 2 starts, firstly host adapter HADkm starts. In this case, host adapter HADkm waits for all storage devices SD0 to SD3 to start in step 62. In step 63 by voluntarily issuing a command, HADkm obtains (i.e., retrieves) necessary address conversion information from all storage devices SD0 to SD3.

When the obtainment of address conversion information completes, behavior for a host interface is determined and then in step 64, connection to the host interface is permitted. The phrase, “Connection to the host interface is permitted” means after permission, requests from host computer Ck will normally be responded to. Therefore, before permission is obtained, even if host computer Ck makes a request, there will be no response.

In this way, according to the exemplary embodiment, by collecting address conversion information from all storage devices SD0 to SD3 every tine the storage devices start, host adapter HADkm can hold updated address conversion information after such an event.

Next, FIG. 7 is an exemplary flowchart showing functioning of host adapter i at the time of a storage device j being increased (e.g., added) in an exemplary storage system 2 in FIG. 2. As evident to the person ordinary skilled in the art, this functioning may be applied to other embodiments.

In FIG. 7, when a storage device SD is added, a host adapter HADkm detects the adjustment (e.g., increase (addition)) of volume via device side interface control part 35 in step 71, and in step 72, obtains address conversion information related to the increased (added volume) storage device SD. Through this procedure, how to show the volume of the increased storage device SD to host computer Ck is determined and in step 73 when host computer Ck searches the volume again, the existence of the increased volume can be notified.

This functioning also may be applied to a decrease of volume. For example, when a storage device SD is removed, a host adapter HADkm detects the adjustment (e.g., decrease) of volume via device side interface control part 35 in step 71′, and in step 72′, deletes address conversion information related to the decreased (removed volume) storage device SD. Through this procedure, how to show the volume of the decreased storage device SD to host computer Ck is determined and in step 73′ when host computer Ck searches the volume again, the amount of the decreased volume can be notified (reported).

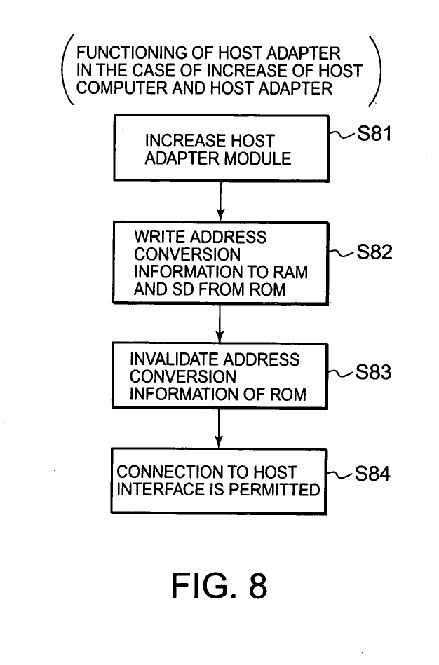

Next, FIG. 8 is an exemplary flowchart showing functioning of host adapter i at the time of increase of a host module (i.e., increase of a host adapter i accompanying increase of a host) in an exemplary storage system 2 in FIG. 2. As evident to the person ordinary skilled in the art, this functioning may be applied to other embodiments.

In FIG. 8, in step 81, host adapter module is increased. In step 82, the host adapter takes out address information from ROM31 and stores it in RAM33 and at the same time, writes it into storage devices SD0 to SD3. Next, in step 83, address conversion information in ROM31 is invalidated. This is because when a new storage is added after this event, the information included in the new storage is given priority. Through the above procedure, how the increased host adapter shows the volume of storage device to a host is determined. Therefore, in step 84 connection to a host interface is permitted.

In this way, in ROM31 of a host adapter to be increased (added), address conversion information is stored, and the increased host adapter writes address conversion information in ROM31 into all storage devices SD0 to SD3 at the time of start. Therefore, a human operation for address information setting is not necessary, and address information in storage devices SD0 to SD3 is automatically updated.

### Third Exemplary Embodiment

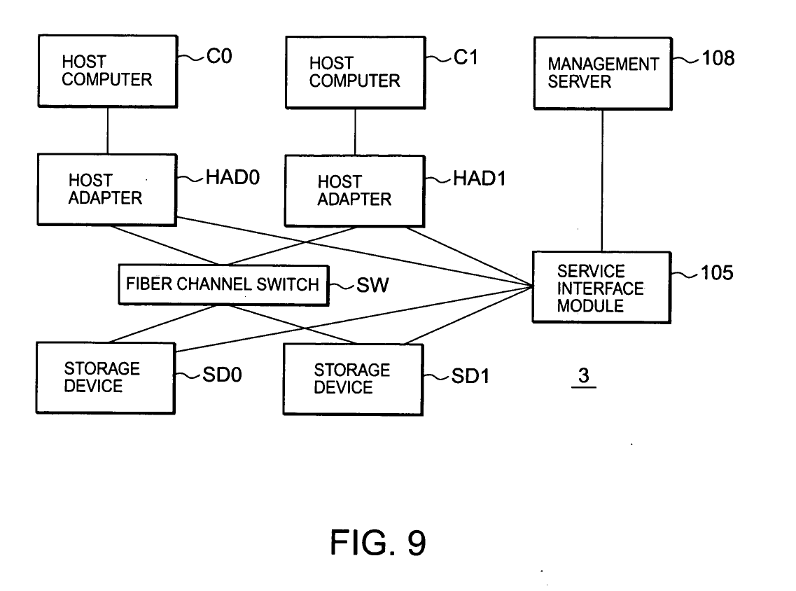

Next, a third exemplary embodiment is described based on FIG. 9. FIG. 9 is an exemplary block diagram showing an exemplary configuration of an integrated storage system 3 wherein information of network elements is managed in an integrated manner according to the third exemplary embodiment of the present invention. As evident to the person ordinary skilled in the art, this storage system 3 may be applied to other exemplary embodiments.

FIG. 9 shows an example of an integrated storage system that carries out integrated management for information of network elements in the third exemplary embodiment. In FIG. 9, the part including FC switch SW, storage device SD0, SD1, host adapter HAD0, HAD1, host computer C0 and C1 of integrated storage system 3 is essentially the same as storage system 1 and 2 in aforesaid first and second exemplary embodiments.

In the third exemplary embodiment as shown in FIG. 9, integrated storage system 3 includes a plurality of storage devices (in FIG. 9, two devices SD0 and SD1) that are connected to a fiber channel SW as a switch device, and at least one computer (in FIG. 9, two host computers C0 and C1) that accesses at least one storage device SD0 and SD1 via aforesaid switch device SW.

In addition, a service interface device 105 is installed that constantly monitors each connection status among each of aforesaid storage devices SD0 and SD1, switch device SW and each host adapter device HAD0 and HAD1. Moreover, a management server 106 is installed that carries out integrated management for information collected by service interface device 105. In this construction, because of easy management, the reliability of devices can be further improved, enabling integrated management of hardware resources.

Further specific explanation is now given. Integrated storage system 3 in FIG. 9 has FC switch SW, service interface device or module 105 that is connected to all network elements (in the example of FIG. 9, storage devices SD0, SD1 and host adapter HAD0 and HAD1) that are directly connected to FC switch SW and management server 106 that is connected to service interface module 105.

Among them, a construction is provided in which the service interface module 105 is connected to each component within integrated storage system 3. Thus, failure and performance information of all components in integrated storage system 3 is managed in an integrated manner and can be reported to management server 106. Additionally, in each of the above configurations of the exemplary embodiment, duplexing of the service interface module 105 can be incorporated so as to maintain durability and reliability in operation.

### Fourth Exemplary Embodiment

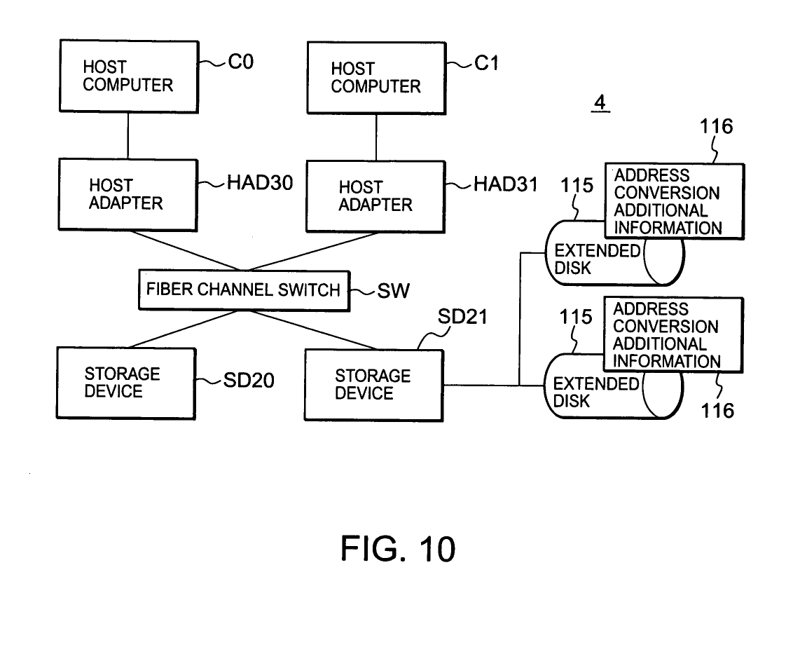

Next, a fourth exemplary embodiment is described based on FIG. 10. FIG. 10 shows the fourth exemplary embodiment in which a characteristic—a second node device (e.g., extended disk 115) is added to aforesaid node device (e.g., storage device). That is, in the fourth exemplary embodiment as shown in FIG. 10, integrated storage system 4 includes a plurality of storage devices (in FIG. 10, two devices SD20 and SD21) that are connected to FC switch SW as a switch device, and at least one computer (in FIG. 10, two host computers C0 and C1) that accesses at least one of the storage devices SD20 and SD21 via aforesaid FC switch SW.

Moreover, a construction is provided in which an extended disk device with address conversion additional information is added to aforesaid storage device, and aforesaid storage device SD20 and SD21 have a conversion information updating function that updates address information held by the storage device based on the address conversion additional information saved in the extended disk device. In this construction, increased versatility results.

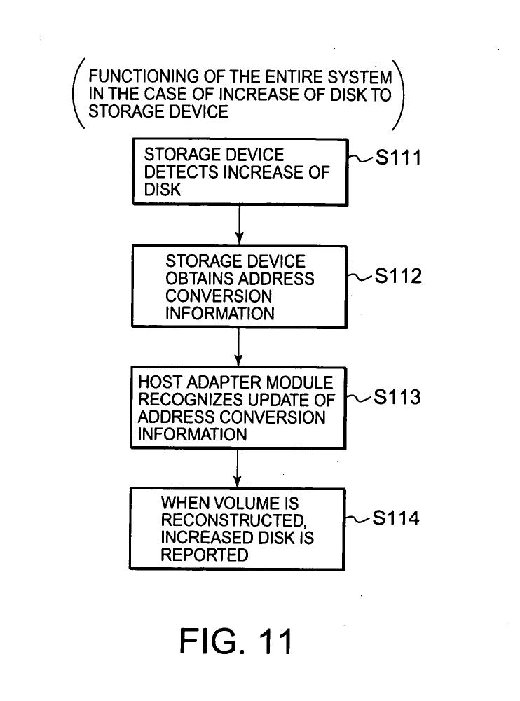

Further description is now given. The fourth exemplary embodiment in FIG. 10 shows an example of a case where a disk device is added to a storage device in operation that is equal to each storage device in each exemplary embodiment mentioned above. FIG. 11 is a flowchart that shows a flow of processing at that time.

Network topology of integrated storage system 4 as shown in FIG. 10 is the same as that in FIG. 9. On the other hand, in FIG. 10, numerals 20 and 21 indicate storage devices SD. Numerals 30 and 31 indicate host adapters HAD. Extended disk 115 to be added under storage SD21 in operation, holds address conversion additional information 116 at the time of shipping.

As shown in FIG. 11, when extended disk 115 is added, firstly in step 111, storage device SD21 detects the addition of disk 115 (e.g., an increased volume). Then, in step 112, storage device SD21 obtains (e.g., reads) address conversion additional information 116 from extended disk 115 and updates address conversion information held by storage device SD21. Then, in step 113, host adapters HAD30 and HAD 31 recognize updated address conversion information 116.

Thus, in the fourth exemplary embodiment, host adapters HAD30 and HAD31 take in (receive) address information at regular time intervals. After that, in step 114, when a host searches the volume again, the increased volume can be notified (reported).

This functioning of the entire system may be applied to the case in which extended disk 115 is removed. For example, when extended disk 115 is removed, firstly in step 111′, storage device SD21 detects the deletion (removal) of disk 115 (e.g., a decreased volume). Then, in step 112, storage device SD21 updates address conversion information held by storage device SD21. Then, in step 113, host adapters HAD30 and HAD 31 recognize updated address conversion information 116.

Host adapters HAD30 and HAD31 take in (receive) address information at regular time intervals. After that, in step 114′, when a host searches the volume again, the decreased volume can be notified (reported).

As described above, in the fourth exemplary embodiment a single disk device 115 that is added under a storage device has address conversion additional information and in this construction, address conversion information held by storage device SD21 is updated. Therefore, an outstanding effect is obtained not only when a storage device itself is increased, but also when a single disk under storage device is added, the operation for increasing can be completed without changing the setting at an installation location. At this point, the existing volume of aforesaid extended disk (single disk device) may be increased in capacity.

In the above description, only an example of exemplary embodiment was given to explain the present invention. Therefore, in accordance with the technical idea or principle of the present invention, it is possible to conduct change, modification or addition to the above-mentioned exemplary embodiment and from such a viewpoint, the present invention is highly versatile in use.

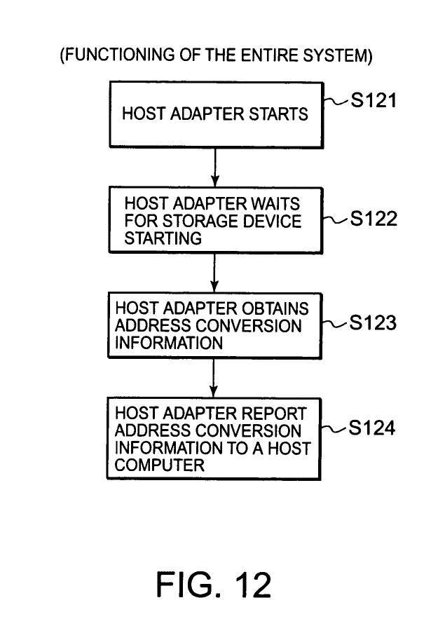

Another control method for starting the system and the like in the exemplary embodiment is shown below. FIG. 12 is another exemplary flowchart showing functioning of the entire system 2 at the time of start in an exemplary storage system 2 in FIG. 2. S123 is different from FIG. 6.

A system start method in the exemplary embodiment includes: a first step wherein a host adapter device starts at the same time of the entire system starting (S121); a second step wherein after each of a plurality of storage devices completes the start (S122), the host adapter device functions and obtains address conversion information held by each of the storage devices (S123); and a third step wherein the obtainment of such address conversion information is reported to a host computer (S124), and hereby the entire system functions normally for requests from the host computer. According to these three steps, at the time of increase and maintenance of a storage device, problems that have occurred at the time of start caused by conventional human errors may be effectively eliminated.

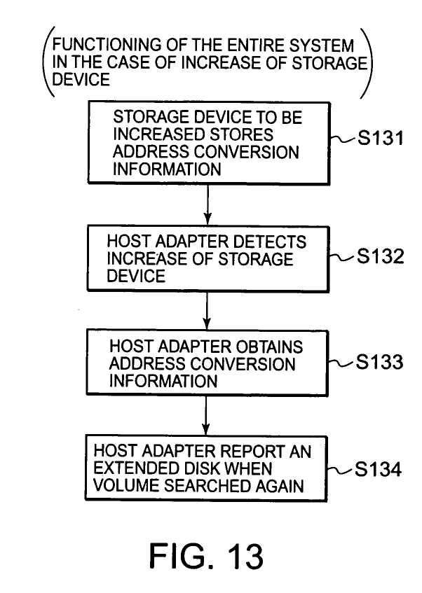

FIG. 13 is another exemplary flowchart showing functioning of the entire system 2 at the time of a storage device j being increased in an exemplary storage system 2 in FIG. 2. S131 is different from FIG. 7.

In a system operation control method at the time of a storage device being increased in the exemplary embodiment includes the following steps: a first step wherein a storage device to be increased stores address conversion information (S131); a second step wherein a host adapter device relating to the increased storage device detects the increase of relevant storage device (S132), a third step wherein based on the detected increase information, address conversion information relating to the increased storage device is obtained (S133), and a fourth step wherein the obtainment of the address conversion information is reported to a host computer and at the same time, the existence of increased volume is notified at the next time of searching from a relevant host computer (S134). This may enable the smooth execution of the operation control of the system at the time of a storage device being increased.

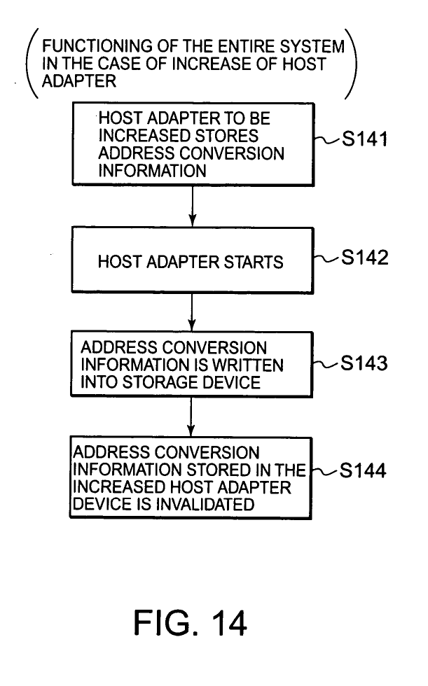

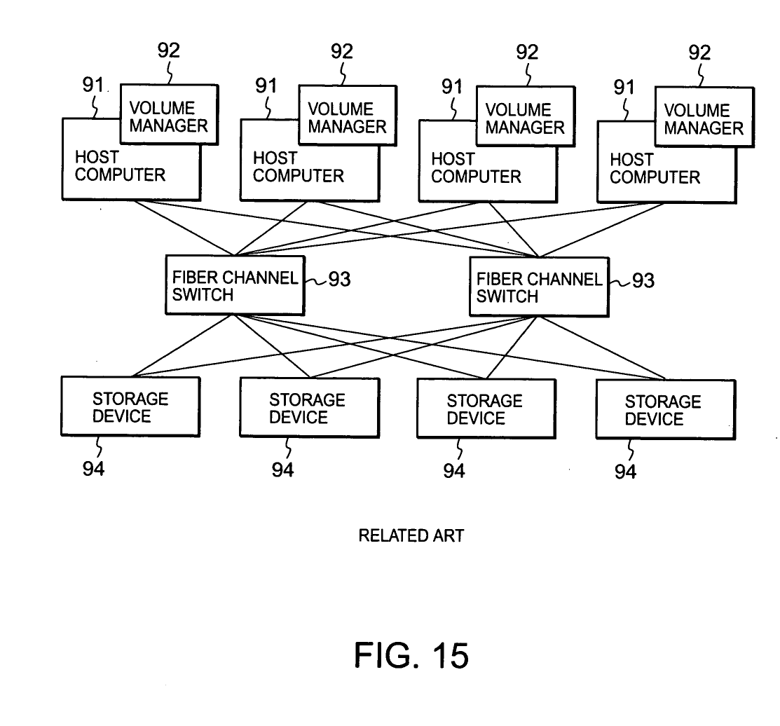

FIG. 14 is another exemplary flowchart showing functioning of host adapter i at the time of increase of a host adapter i accompanying increase of a host in an exemplary storage system 2 in FIG. 2. S141 is different from FIG. 8.

Furthermore, in a system operation control method at the time of a host adapter being increased in the exemplary embodiment includes the following steps: a first step wherein a host adapter device to be increased stores address conversion information relating to each of a plurality of storage devices (S141); a second step wherein the increased host adapter device starts (S142); a third step wherein address conversion information stored in the increased host adapter device is written into each of the storage device (S143); and a fourth step wherein address conversion information stored in the increased host adapter device in the first step is invalidated (S144). This may enable the smooth execution of the operation control of the system at the tine of a host adapter device being increased.

[A Control Program for Starting the System and the Like in the Exemplary Embodiment]

A start control program relating to the exemplary embodiment has a construction allowing that a computer may execute the following procedures: a procedure to start a host adapter device concurrently with the start of the entire system; a procedure to obtain address conversion information held by each of a plurality of storage devices by having the host adapter device function after each of the storage devices completes the start; and a procedure to report the obtainment of such address conversion information to a host computer.

In addition, a start control program relating to the exemplary embodiment may be a control program to allow that a computer executes system operation control at the time of a storage device being increased in an integrated storage system and has a construction allowing that the computer executes the following procedures: a procedure wherein a storage device to be increased stores address conversion information; a procedure wherein a host adapter device relating to the increased storage device detects the increase in relevant storage device; a procedure to function based on detected increase information and obtain address conversion information relating to the increased storage device; and a procedure to report the obtainment of such address conversion information to a host computer and at the same time, notify the existence of increased volume at the next time of searching from a relevant host computer.

Furthermore, a control program relating to the exemplary embodiment may be a control program allowing that a computer executes system operation control at the time of a host adapter device being increased in an integrated storage system and has a construction ensuring that the computer executes the following procedures: a procedure wherein a host adapter device to be increased stores address conversion information relating to each of a plurality of storage devices; a procedure to start the increased host adapter device; a procedure wherein address conversion information stored in the increased host adapter device is written into each of the storage device, and a procedure to invalidate address conversion information stored in the increased host adapter device in the first step. Even in these procedures, a program capable of effectively achieving the above-mentioned purpose can be provided.

In this way, in each exemplary embodiment described above, the present invention may include many exemplary advantages. For example:

(1) with regards to a storage device in which address conversion information is stored before shipping, a setting is made that when a host adapter device detects an increase, such information is automatically taken in; therefore, at the time of a storage device being increased, the operation can be automatically completed without changing the setting at an installation location and human errors that have conventionally occurred may be completely eliminated; this may give a significant increase in the reliability of the entire system;

(2) with regards to a host adapter device in which address conversion information is stored before shipping, a setting is made that a host adapter device automatically writes such information into a single storage device at the first time of start; therefore, at the time of a host adapter device being increased, the operation may be completed without changing the setting at an installation location and in this case as well, human errors that have conventionally occurred are completely eliminated; this may also give a significant increase in the reliability of the entire system; and

(3) even when a host adapter device is replaced due to failure of a host adapter device, address conversion information may be automatically taken in again; therefore, the operation for replacement may be completed without resetting of information.

The present invention has the above-mentioned construction and functions. Therefore, at the tine of replacement due to failure or maintenance of each component of a system device relating to an integrated storage system, logical setting operation at an installation location may not be necessary. Thus, occurrence of human error may be eliminated. Accordingly, the present invention may provide a highly reliable integrated storage system, start method and its program.

At this point, it is possible to realize each exemplary embodiment mode mentioned above by incorporating a host adapter HAD into a switch device or fiber channel switch SW. In this case, a host adapter HAD may take the form of a host adapter module.

In the same way, a service interface 105 in FIG. 9 may be realized as an independent device or in a form wherein it is installed on a slot of a FC switch SW. Or, a construction may be provided wherein any of host adapter HADi has a service interface module 105 built-in.

While this invention has been described with reference to exemplary embodiments, this description is not intended as limiting. Various modifications of the illustrative embodiments, as well as other embodiments of the invention, will be apparent to persons skilled in the art upon taking description as a whole. It is, therefore, contemplated that the appended claims will cover any such modifications or embodiments as fall within the true scope of the invention.

Further, the inventor's intent is to encompass all equivalents of all the elements of the claimed invention even if the claims are amended during prosecution.

This application is based on Japanese Patent Application No. 2005-104169 filed on Mar. 31, 2005 and including specification, claims, drawings and summary. The disclosure of the above Japanese Patent Application is incorporated herein by reference in its entirety.

What is claimed is:

1. A storage system for use with a node device, said storage system comprising:
host modules that access the node device based on an address conversion information,
wherein said node device is connectable to said host modules and includes said address conversion information.

2. The storage system according to claim 1,
wherein said address conversion information includes an information of address conversion between a host module of said host modules and said node device.

3. The storage system according to claim 2,
wherein said node device includes said address conversion information with respect to each of said host modules.

4. The storage system according to claim 1,
wherein a host module of said host modules retrieves said address conversion information from said node device.

5. The storage system according to claim 1, further comprising:
a service interface module that monitors connection status among said node device and said host modules; and
a management server that carries out integrated management for information gathered by said service interface device.

6. The storage system according to claim 1, wherein one of said host modules includes:
a host computer; and
a host adapter that controls data transfer between said host computer and said node device.

7. The storage system according to claim 1, further comprising:
a second node device that is connectable to said node device, said second node device storing said address conversion information.

8. The storage system according to claim 7,
wherein said node device includes a data storage.

9. The storage system according to claim 8, wherein said data storage retrieves said address conversion information from said second node device.

10. The storage system according to claim 9, wherein said data storage updates said address conversion information based on said address conversion information retrieved from said second node device.

11. A storage system for use with a host adapter, said storage system comprising:
node devices; and
a host computer that accesses said node devices,
wherein said host adapter is connectable to said host computer and controls data transfer between said host computer and said node devices, and said host adapter includes said address conversion information.

12. The storage system according to claim 11,
wherein said address conversion information includes an information of address conversion between said host adapter and one of said node devices.

13. The storage system according to claim 11,
wherein said host adapter includes said address conversion information with respect to each of said node devices.

14. The storage system according to claim 11,
wherein one of said node devices is written with said address conversion information from said host adapter.

15. The storage system according to claim 11, wherein said host adapter includes:
a read-only memory (ROM) that includes said information of address conversion between said host adapter and one of said node devices; and
a random access memory (RAM),
wherein said information of address conversion between said host adapter and said one of said node devices is written to said RAM and said one of said node devices.

16. The storage system according to claim 15,
wherein said ROM is invalidated after said address conversion information is written to said RAM and said one of said node devices.

17. A host adapter within a storage system, said storage system comprising:
a host computer, wherein:
said node device is connectable to said host computer and includes an address conversion information; and
the host adapter controls data transfer between said host computer and said node device based on said address conversion information.

18. A host adapter within a storage system, said storage system comprising:
node devices; and
a host computer that accesses said node devices,
wherein said host adapter comprises:
an address conversion information,
wherein said host adapter is connectable to said host computer and controls data transfer between said host computer and said node devices.

19. A node device within a storage system, comprising:
host modules that access the node device based on an address conversion information,
wherein said node device comprises:
said address conversion information,
wherein said node device is connectable to said host modules.

20. A method of controlling a storage system for use with a node device, said storage system comprising:
a host computer; and
a host adapter that controls data transfer between said host computer and a node device based on an information of address conversion between said host computer and said node device, said node device being connectable to said storage system,
wherein said method comprises:
retrieving, by said host adapter, said address conversion information from said node device.

21. The method of controlling a storage system according to claim 20, further comprising:
permitting said host adapter to connect to said host interface.

22. The method of controlling a storage system according to claim 20, further comprising:
starting the host adapter; and
waiting for said node device to start.

23. The method of controlling a storage system according to claim 20, further comprising:
detecting an adjustment in volume of said node device.

24. The method of controlling a storage system according to claim 23, further comprising:
detecting an increase in volume of said node device.

25. The method of controlling a storage system according to claim 23, further comprising:
detecting a decrease in volume of said node device.

26. The method of controlling a storage system according to claim 23, further comprising:
reporting said adjustment in volume of said node device to said host computer, when said host computer searches said volume.

27. The method of controlling a storage system according to claim 20, said method comprising:
detecting an adjustment of a second node device attached to said node device.

28. The method of controlling a storage system according to claim 27, said method further comprising:
detecting an addition of said second node device attached to said node device.

29. The method of controlling a storage system according to claim 27, said method further comprising:
detecting a deletion of said second node device attached to said node device.

30. The method of controlling a storage system according to claim 27, said method further comprising:
retrieving said address conversion information from said second node device; and
updating said address conversion information.

31. The method of controlling a storage system according to claim 30, further comprising:
recognizing an update of said address conversion information of said node device.

32. The method of controlling a storage system according to claim 31, further comprising:
reporting said increase of a volume of said second node device to said host computer, when said host computer searches said volume.

33. A method of controlling a host adapter within a storage system, said storage system comprising:
node devices; and
a host computer that accesses one of said node devices,
wherein said host adapter is connectable to said host computer and controls data transfer between said host computer and said node device, said host adapter including information of address conversion between said host adapter and said node device,
wherein said method comprises:
increasing a number of said host adapter; and
said host adapter writing said address conversion information to one of said node devices.

34. The method of controlling a host adapter according to claim 33, further comprising:
writing said address conversion information stored in a ROM of said host adapter to a RAM of said host adapter.

35. The method of controlling a host adapter according to claim 34, further comprising:
invalidating said address conversion information of said ROM.

36. The method of controlling a host adapter according to claim 35, further comprising:
permitting connection to a host interface.

37. A signal-bearing medium embodying a program of machine-readable instructions executable by a digital processing apparatus, said program causing a host adapter to perform a method of claim 20.

38. A signal-bearing medium embodying a program of machine-readable instructions executable by a digital processing apparatus, said program causing said digital processing apparatus to perform a method of claim 33.
